(19) United States
(12) Patent Application Publication
(10) Pub. No.: US 2010/0193418 A1
(43) Pub. Date: Aug. 5, 2010

(54) Storm water treatment system, modular drain vault, tube cleaning tool and methods

(76) Inventor: David Belasco, Westminster, CA (US)

Correspondence Address: CONNORS ASSOCIATES, 1600 DOVE ST, SUITE 220, NEWPORT BEACH, CA, 92660, US

(21) Appl. No.: 12/696,057

(22) Filed: Jan. 29, 2010

Related U.S. Application Data
(60) Provisional application No. 61/206,406, filed on Jan. 29, 2009.
(60) Provisional application No. 61/207,307, filed on Feb. 10, 2009.
(60) Provisional application No. 61/216,533, filed on May 18, 2009.

(51) Int. Cl. E03F 5/10; B08B 9/04

(52) U.S. Cl. 210/137; 210/170.03; 210/521; 134/166 C; 134/22.12

(57) ABSTRACT

Methods, systems, drain vaults, and tools are employed to treat storm water runoff from a watershed. The methods and system may include multiple drain vaults that function to receive and allow quiescence of the water so that laminate flow may be achieved between adjacent vaults. The drain vaults may be made of stacked together vault sections held in compression, and screens and arrays of tube elements are with different drain vaults. There may be combined systems where in an upstream system flow is uncontrolled during a rainstorm and some of the rainfall water is diverted to a retention structure and then in a control flow rate is transferred to a downstream treatment system that may use tube elements. A tool is used to clean the tube elements.

### RELATED PATENT APPLICATIONS & INCORPORATION BY REFERENCE

This application claims the benefit under 35 USC 119(e) of U. S. Provisional Patent Application No. 61/206,406, entitled Dissolved Pollutant & Bacterial Removal Device & Method filed Jan. 29, 2009, U. S. Provisional Patent Application No. 61/207,307, entitled Storm Water Pre-Filtration Device & Method filed Feb. 10, 2009, and U. S. Provisional Patent Application No. 61/216,533, entitled Storm Water Treatment Dewatering/Infiltration System & Method filed May 18, 2009. These related provisional applications are incorporated herein by reference and made a part of this application. If any conflict arises between the disclosure of the invention in this utility application and that in the related provisional applications, the disclosure in this utility application shall govern. Moreover, any and all U.S. patents, U.S. patent applications, and other documents, hard copy or electronic, cited or referred to in this application are incorporated herein by reference and made a part of this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The word “rectangular” includes square.

### BACKGROUND

Storm water treatment, particularly on urban sites, must be accomplished across an extraordinarily broad range of flow rates, since rainfall intensity varies significantly from one rain fall to another and within each individual rain fall event. Environmental agency requirements require treatment of storm water from watersheds in certain locations. Compliance is achieved when some specified fraction, less than the total maximum storm water runoff volume for any particular site, is treated for removal of whatever contaminants are mandated, for example, total suspended solids (TSS), total oil & grease (TOG), bacteria or specific contaminants dissolved in the storm water. Substantially all contaminants are carried off the watershed surfaces by nearly all levels of rainfall intensity occurring within the first 15 minutes or so after initiation of rainfall. This phenomenon is referred to as “first flush.” Consequently, storm water treatment systems are designed so a selected fraction of total runoff water volume entering the treatment system to be treated for the removal of specified contaminants based upon a specific “design storm” considered appropriate for each site. To be effective a treatment system must have the ability to process a specified fraction to be treated using the treatment system's pathway (total volume) and the remaining fraction, will bypassed treatment along a different route.

With the advent of West Nile Virus, an additional imperative has surfaced: the need to prevent mosquito development in water left standing within the treatment system post-rainfall. This can be easily accomplished if standing water has a drain-down pathway to follow automatically which enables drain-down to a level below filter structures which would then prevent flying insect access to/from that residual water within three days following each rain event.

Moreover, it is desirable to remove suspended solids from the discharged treated water. The range of suspended particle sizes that can be captured is dependent on the velocity at which the water travels through the system. This makes the system configuration and sizing for water retention time and velocity control a critical factor. Efficient, cost-effective storm water treatment is best achieved using a combination of methods in series called a “treatment train.” Such treatment trains typically position treatment system elements in series for removal of, for example, larger suspended particle sizes, followed by smaller suspended particle sizes, followed by bacterial removal and then dissolved contaminants. While this can be done anywhere, it can be prohibitively expensive and, on flat sites with little elevation gradient, difficult to accomplish by gravity alone.

Treatment system usually include above or below ground vaults that are (a) either site-built by framing forms for casting concrete structures inside an space in which they will reside or (b) acquired pre-cast concrete structures from sources close enough to the site (<150 miles) that the structures can be delivered using vehicles equipped with a crane suitable to lift each pre-cast section and set it into its appropriate excavation. Preferably rectangular ports are formed by the pre-caster since only round ports can be core-drilled on site using powered equipment capable of cutting through concrete of 3000 psi compressive strength and the steel rebar reinforced concrete walls.

If pre-cast modular sections capable of being stacked to create vaults of whatever depth are needed could be sized to weigh of less than 2500 lbs, such modular sections could be handled on site using equipment which is typically available, thus enabling modular section delivery to sites and on-site storage awaiting installation into excavations using available equipment. Drain vaults made from modular sections are discussed in my U.S. patent application Ser. No. 12/485,690. If such modular units could be made of lightweight concrete producing modules of less than 1500 lbs, it would be possible to ship palletized modular sections anywhere without the 150 mile radius limit. Further, if modular sections could be formed of plastic or fiberglass materials, on-site handling could be accomplished manually if needed.

Finally, in order to keep treatment systems functional and minimize project life cost, they must periodically be inspected and cleaned, removing and disposing of collected contaminants, for example, replacing absorbent materials which collect dissolved solids, removing and disposing of collected bacterial colony mass, cleaning or replacing filter media and disposing of collected suspended solids.

### SUMMARY

My drain vault, system, tool and methods have one or more of the features depicted in the embodiments discussed in the section entitled “DETAILED DESCRIPTION OF SOME ILLUSTRATIVE EMBODIMENTS.” The claims that follow define my drain vault, system, tool and methods, distinguishing them from the prior art; however, without limiting the scope of my drain vault, system, tool and methods as expressed by these claims, in general terms, some, but not necessarily all, of their features are:

One, a drain inlet vault may be used comprising a plurality of complementary vault sections configured to be vertically stacked one upon the other to form the vault. The vault sections may be made of pre-cast, light-weight concrete and have a weight that does not exceed approximately 1500 pounds. The vault sections may have at least one sidewall that is devoid of internal structure that would interfere with cutting through the wall at essentially any selected point along the wall. In other words, no steel bar reinforcement. The concrete forming the wall has minimum compressive strength of 2000 pound per square inch (psi) and minimum flexural strength of 1300 psi.

Two, an elongated coupling element may extend along a passageway in walls of the sections to connect the vault sections together and apply a compressive force against the stacked vault sections to keep the vault sections in a vertical configuration. The passageway may be located in one or more corners of the sections and the elongated coupling elements may include a threaded rod and connecting devices mounted on opposed ends of the rod to manually torque the connecting devices after inserting the rod into a corresponding passageway so the vault sections snugly engage each other.

Three, a substantially planar, non-clogging and self-cleaning screen is within a treatment vault that selectively removes solids having an average particle size greater than 150 microns and collects such particles on a surface of the screen. The screen may be oriented at an angle and slope between an inlet port and an outlet port and positioned so that substantially all the water flowing into the treatment vault flows through the screen. The screen has a perimeter that is held between adjacent vault sections on a slant. This arrangement is used to assist in establishing laminar flow across surface of the screen on solids collect.

Four, my system includes numerous embodiments providing enhanced water treatment of storm water flowing from a watershed site during a rain storm. One of my systems includes a receiver vault and a first and second treatment vaults at the site in communication with each other so water from the site first flows into the receiver vault where turbulence in the water is reduced. Then the water flows into the first treatment vault and then from the first treatment vault into the second treatment vault. A slanted planar, non-clogging and self-cleaning screen is within the first treatment vault and it selectively removes solids having an average particle size greater than 150 microns and collects such particles on an exterior surface of the screen. A treatment vault may be used having first and second treatment outlet ports and an inlet port at an elevation substantially the same as a predetermined elevation of the receiver outlet port. The receiver outlet port and treatment inlet port may be essentially contiguous so water flows directly from the receiver vault through the contiguous receiver outlet port and treatment inlet port. The receiver vault may have a predetermined capacity based on the normally anticipated rain fall on the site during a rain storm to allow water to collect and slowly fill the receiver vault to reduce turbulence of water in the receiver vault and to regulate the flow rate of the water through the contiguous ports so the flow approaches substantial laminar flow.

Another embodiment of my system includes a plurality of permeable rigid tubular devices oriented to enable water to penetrate permeable walls of the tubular devices and discharge from an end thereof and out a treatment vault. The flow rate of the water flowing through the tubular devices provides sufficient contact time for bacteria entrained in the flowing water to colonize exterior surfaces of the tubular devices, which may have fine mesh covers and which may comprise a pair of concentric permeable tubes having a spaced between them filled with water treatment media.

A different embodiment of my system includes first and second banks of drain vaults in communication with each other to treat storm water flowing from the site. The first bank of vaults includes a treatment vault including a slanted screen and a drainage vault downstream of the treatment vault. Treated water from the first bank flows into a retention structure and is retained therein for further treatment. Downstream from the retention structure is the second bank, which has a drain vault including a plurality of permeable rigid tubular devices oriented to enable water to penetrate porous walls of the tubular devices and discharge from an end thereof and the second bank. A pump pumps water from the retention structure at a constant flow rate into the second bank. A flow control device enables the pump to be operated to transfer water in the retention structure upon sensing when the water level in the drain vault in the second bank is below the tubular devices.

Another embodiment of my system includes a drain vault having a diversion weir device near an inlet port thereof so that water may flow to, under and over the weir device to divert flow to an outlet port of the vault. There is a lower outlet port near a bottom of the vault where effluent water containing the maximum entrained solids content exits the vault, and an upper by-pass port where effluent water containing the minimum entrained solids content exits the vault.

Five, a tool is used for cleaning the tube elements that has a porous wall with an internal surface and a predetermined inside diameter. The tool includes an elongated shaft having a first end including a manually operated control valve adapted to be connected to a source of cleaning liquid and a second end that is closed. The shaft is hollow to provide a channel for cleaning liquid flowing internally along the hollow shaft. There is an orifice near the second end that is in communication with the channel. A pair of resilient elements mounted along the shaft in a fixed position straddle the orifice. Each resilient element has a diameter that is slightly greater than the inside diameter of the tube being cleaned. The resilient element are compressed upon inserting the tool into an open end of the tube to form a seal between the resilient elements and the internal surface of the tube. The seal, however, allows the tool to be moved reciprocally as the valve is actuated to enable cleaning liquid to flow along the channel and out the orifice under pressure and through the porous wall of the tube element. The internal surface of the porous wall may be substantially cylindrical and the resilient elements are substantially spherical. The resilient elements may have a tough external skin and a softer internal core.

These features are not listed in any rank order nor is this list intended to be exhaustive.

### DESCRIPTION OF THE DRAWING

Some embodiments of my drain vault, system, tool and methods, illustrating all their features, will now be discussed in detail in connection with the accompanying drawing, which is for illustrative purposes only. This drawing includes the following figures (FIGS.), with like numerals indicating like parts:

FIG. 1 is a perspective view of one embodiment of my storm water treatment system.

FIG. 1A is a perspective view of an alternate embodiment of my storm water treatment system.

FIG. 2 is a perspective of one embodiment of a base vault section of my modular drain vault.

FIG. 2AA is a cross-sectional view taken along line 2AA-2AA of FIG. 2.

FIG. 2A is a perspective view of one embodiment of a base-riser vault section of my drain vault.

FIG. 2AB is a cross-sectional view taken along line 2AB-2AB of FIG. 2A.

FIG. 2AAA is a perspective view of another embodiment of the base vault section of my drain vault.

FIG. 2AABA is a cross-sectional view taken along line 2AABA-2AABA of FIG. 2AAA.

FIG. 2ABB is a perspective view of another embodiment of the base vault section of my drain vault.

FIG. 2ABBA is a cross-sectional view taken along line 2ABBA-2ABBA of FIG. 2ABB.

FIG. 2BD is a cross-sectional view showing the rod of the steel rod compression/reinforcement assembly illustrated in FIGS. 2B and 2BA.

FIG. 2BDB is a plan view of a square washer of the steel rod compression/reinforcement assembly that function as a means for applying a compressive force to stacked together vault sections.

FIG. 2BDA is a cross-sectional view showing of an assembled washer and nut of the steel rod compression/reinforcement assembly depicted in FIG. 2BD.

FIG. 3 is a perspective view of one embodiment of a riser section of my drain vault.

FIG. 3AA is a cross-sectional view taken along line 3AA-3AA of FIG. 3.

FIG. 4 is a perspective view of one embodiment of a cap section of my drain vault employing a grated cover.

FIG. 4AAA is a cross-sectional view taken along line 4AAA-4AAA of FIG. 4.

FIG. 4AAB is a cross-sectional view of another embodiment of a cap section of my drain vault employing a 300 psi aluminum solid cover.

FIG. 4AAC is a cross-sectional view of a cap section of my drain vault employing an H20 steel solid cover.

FIG. 5 is a perspective view of one embodiment of a culvert section of my drain vault.

FIG. 5AA is a cross-sectional view taken along line 5AA-5AA of FIG. 5.

FIG. 5AB is a cross-sectional view of an alternate embodiment of a culvert section of my drain vault with removable solid cover.

FIG. 5AC is a cross-sectional view of an alternate embodiment of a culvert section of my drain vault that is fully enclosed without any removable cover.

FIG. 6 is a perspective view of one embodiment of a stainless steel, self-cleaning, non-clogging wedgewire filter used in my system.

FIG. 6A is a perspective view of an alternative embodiment of a stainless steel, self-cleaning, non-clogging wedgewire filter used in my system.

FIG. 7 is an exploded, cross-sectional view of a receiver vault comprised of the base section of FIG. 2AB, the riser section of FIG. 3AA, and the cap section of FIG. 4AAA.

FIG. 7BB is an enlarged cross-sectional view of an alternative embodiment of a stabilizing steel rod compression/reinforcement assembly within a passageway in a corner of assembled vault sections shown in FIG. 7.

FIG. 7BC is an elevation view of the steel rod compression/reinforcement device used in the embodiment shown in FIG. 7BB.

FIG. 7BCA is an enlarged fragmentary elevation view of the steel rod compression/reinforcement device used in the embodiment shown in FIG. 7BB.

FIG. 7CCA is an enlarged cross-sectional view of an elongated washer with the rod of the steel rod compression/reinforcement assembly shown in FIG. 7BC passing through the washer.

FIG. 8 is a perspective view of one embodiment of a treatment drain vault used in my system.

FIG. 8AA is a cross-sectional view of taken along line 8AA-8AA of FIG. 8.

FIG. 9 is a perspective view of one embodiment of a solids receiving and drainage drain vault used in my system.

FIG. 9AA is a cross-sectional view of taken along line 9AA-9AA of FIG. 9.

FIG. 10 is a cross-sectional view of an alternative embodiment of my treatment system.

FIG. 11 is a perspective view of one embodiment of a receiver vault of my treatment system.

FIG. 11AA is a cross-sectional view of taken along line 11AA-11AA of FIG. 11.

FIG. 12 is a perspective view of one embodiment of a treatment vault of my treatment system.

FIG. 12AA is a cross-sectional view of taken along line 12AA-12AA of FIG. 12.

FIG. 12A shows one embodiment of a tubular media device used in my system with

FIG. 12A91 being the cross-sectional view of the tubular media device,

FIG. 12A91a is a plan view of the primary support structure of the tubular media device,

FIG. 12A91b being a plan view of the frame support and frame structure of the tubular media device,

FIG. 12A91c being a plan view of the top support structure of the tubular media device,

FIG. 12A91d being a plan view of the bottom support structure of the tubular media device.

FIG. 12A1 is a cross-sectional view taken along line 12A1-12A1 of FIG. 12A91.

FIG. 13 is a perspective view of an alternative embodiment of a treatment vault of my treatment system.

FIG. 13AA is a cross-sectional view of taken along line 13AA-13AA of FIG. 13.

FIG. 13A shows an alternate embodiment of a tubular media device used in my system with

FIG. 13A101 being a cross-sectional view of this alternate embodiment of a tubular media device,

FIG. 13A102 being a elevation view of a manifold tank of this alternate embodiment of a tubular media device,

FIG. 13A101a is a plan view of the primary support structure of this alternate embodiment of a tubular media device,

FIG. 13A101b is a plan view of the frame support and frame structure of this alternate embodiment of a tubular media device,

FIG. 13A101c is a plan view of the top support structure of this alternate embodiment of a tubular media device.

FIG. 14 is a perspective view of one embodiment of a discharge vault of my storm water treatment system.

FIG. 14AA is a cross-sectional view of taken along line 14AA-14AA of FIG. 14.

FIG. 15 is a cross-sectional view of still an alternative embodiment of treatment system.

FIG. 16 is a cross-sectional view of yet another alternative embodiment of my treatment system.

FIG. 17 is a cross-sectional view of another alternative embodiment of my treatment system.

FIG. 18 is an elevation view of my tool being used to clean a permeable tube element used in some embodiments of my storm water treatment system.

FIG. 18AB is a cross-sectional view taken along line 18AB of FIG. 18 showing my tool of inserted into a vertically oriented permeable tube element with the distal end of the tool almost touching the bottom of the tube element.

### DETAILED DESCRIPTION OF SOME ILLUSTRATIVE EMBODIMENTS

### General

Storm water drain vaults used in my storm water runoff treatment system may be comprised of two or more vertically stacked, prefabricated vault sections, for example, a base or base-riser section and at least one riser section and/or a cap section. The stacked together vault sections may be further joined together by insertion through walls of the sections vertical coupling elements such as, for example, an adjustable steel rod compression/reinforcement device.

Pre-fabricated stainless steel internal support structures may be installed in my drain vault with integral positioning elements to assist in properly locating internal support structures on a top surface of a lower section. This prevents horizontal movement so that the support structure is secured in position at a joint between sections. For example, as in the case of cast concrete sections, a tongue-in-groove type joint may be between vault sections. The mass of the upper vault section(s) when lowered into place from above bears on the lower section(s) and holds the support structure in place.

The prefabricated vault sections may have one or more openings in its walls as needed to enable proper positioning of any filter system element(s), passage of appropriate liquid volumes through the support structure. The vault sections walls, however, must be strong enough to support planned loading, including personnel entering the vault for periodic inspection and or cleaning Support structures may enable positioning of a Coanda-style stainless steel wedge-wire self-cleaning screens, Hydro-Master bottom filters to collect and de-water deposited suspended solids particles, and the Hydro-Master permeable tube element used in some embodiments of my treatment system. Hydro-Master is a trademark product of Storm Water Filter Corporation in Orange County, Calif. In the case of cast concrete or lightweight high performance fiber reinforced cellular concrete (HPFRCC) sections, leakage of water through the interstitial vault joint space(s) may be prevented by positioning an appropriate sealant in the joint, such as, for example, a butyl tape meeting the requirements of ASTM C443.

Modular vault sections may be constructed so that, upon assembly, the joints formed between vaults may be located at specific elevation(s) most useful for positioning a support structure to enable needed treatment equipment to be properly located within a particular vault interior space, while still allowing installation and/or removal of filtration equipment above and below each such support structure, plus access for periodic visual inspection and physical cleanout. By altering the plan dimensions of modular sections, the treatment capacity rating of assembled vault systems can be pre-determined. For example a 3 ft×3 ft inside dimensions of a square cavity vault, of a particular depth, might be rated at ˜3 cubic feet per second (cfs), a 3 ft×6 ft at ˜6 cfs, and a 3 ft×9 ft vault at ˜9 cfs, etc. The modular vault sections may be manufactured using a lightweight HPFRCC concrete material of Substiwood, Inc. of Milwaukee, Wis., which can reduce the weight of individual modular sections sufficiently to allow them to be shipped anywhere in the country and be off-loaded and handled using equipment generally found on most construction sites. U.S. Pat. No. 6,911,076 describes this material. Further, this particular lightweight concrete material can be cut using readily available power equipment designed for cutting structural lumber, avoiding the need for rental specialized concrete hole sawing equipment and allowing ports for round or rectangular inlet and outlet flow to be easily cut on site after assembling the sections into a vault in its excavation.

My system and methods enable storm water treatment meeting leadership in energy and environmental design (LEED) criteria. For example, treatment train comprising first-stage >150 micron total dissolved solids (TSS) removal using Coanda screens, followed by fine TSS removal using a permeable tubular or other media, followed by dissolved contaminant removal using the permeable tubular or other media. The permeable tube equipment and methods for TSS removal may be configured into mobile systems with high-suction pumps to be used on sites for the periodic removal of fine solids from drainage tank structures. My systems using the permeable tube equipment and methods for TSS removal will be capable of simplified in-situ cleaning of the permeable tubes using my tube cleaning tool and methods.

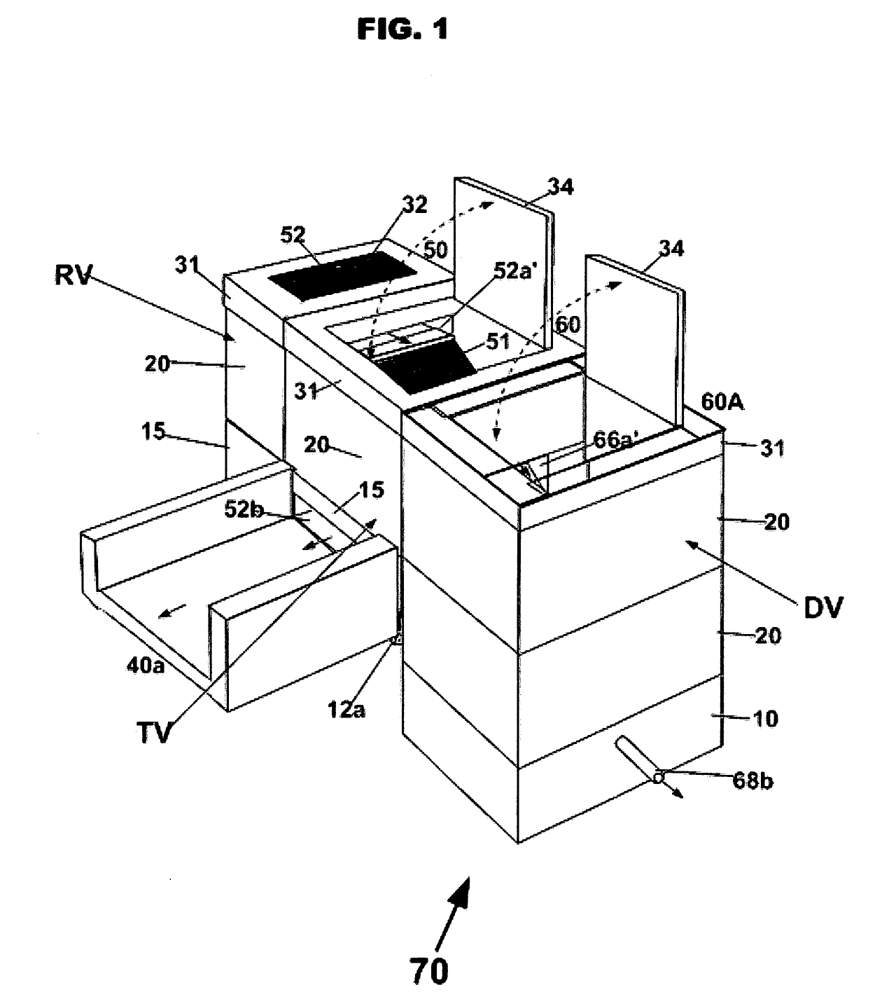

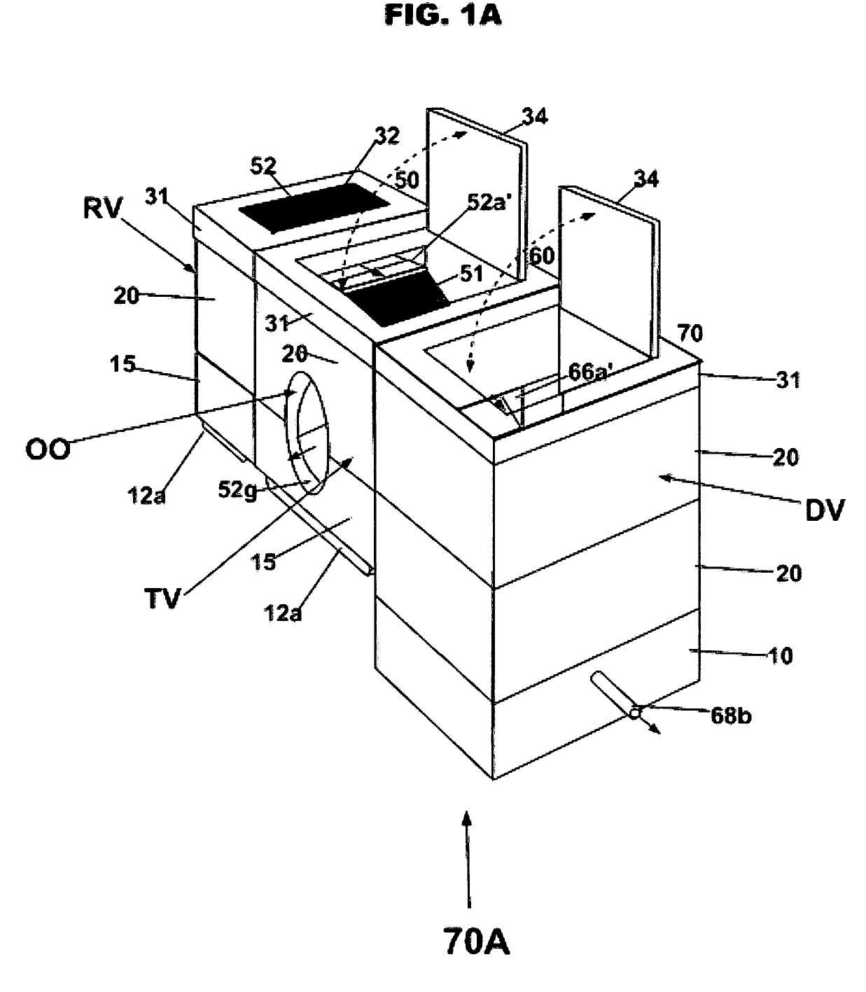

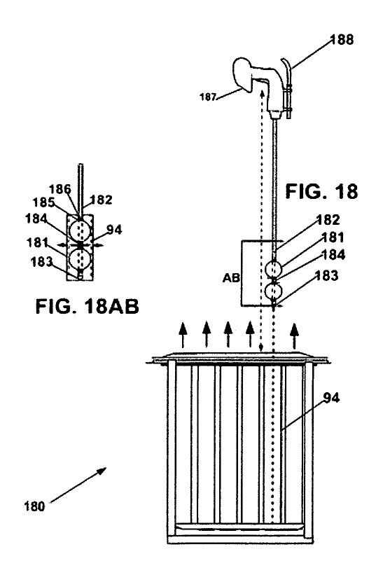

FIGS. 1, 1A, 10, 13, 15, 16, and 17 depict alternate embodiments of my drain vaults and storm water treatment systems and methods of treating storm water, and FIGS. 18 and 18AB depict an embodiment of my permeable tube cleaning tool an method.

### FIGS. 1-9

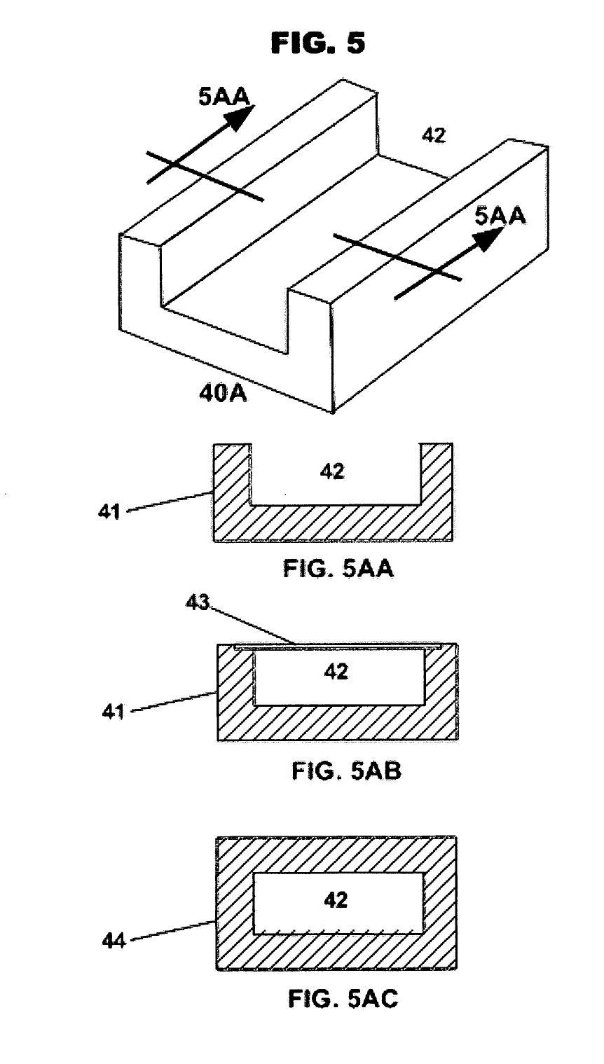

FIG. 1 depicts one embodiment of my storm water runoff treatment system designated by the numeral 70. My system 70 comprises a receiver vault RV, a treatment vault TV, and a drainage vault DV for solids collection and drainage. These vaults may be installed above or below ground level at a site for treatment of storm water flowing from the site. These vaults are in communication with each other so the storm water to be treated flows from the site into the receiver vault RV, then from the receiver vault into the treatment vault TV, and then flows from the treatment vault into drainage vault DV. These vaults have predetermined sizes and include predetermined sized inlets and outlets so at a predetermined flow rate substantially all the storm water from the site is treated to selectively remove contaminants, and above this predetermined flow rate substantially all the storm water from the site is bypassed and not treated, or more vaults are deployed in parallel to accomplish treatment of all the storm water run off. FIG. 1A depicts an alternate embodiment of my pre-treatment system designated by the numeral 70A, which has a circular port 52g replacing an culvert 40a (FIGS. 5, 5AA, 5AB, and 5AC) and outlet port 52b of the system 70.

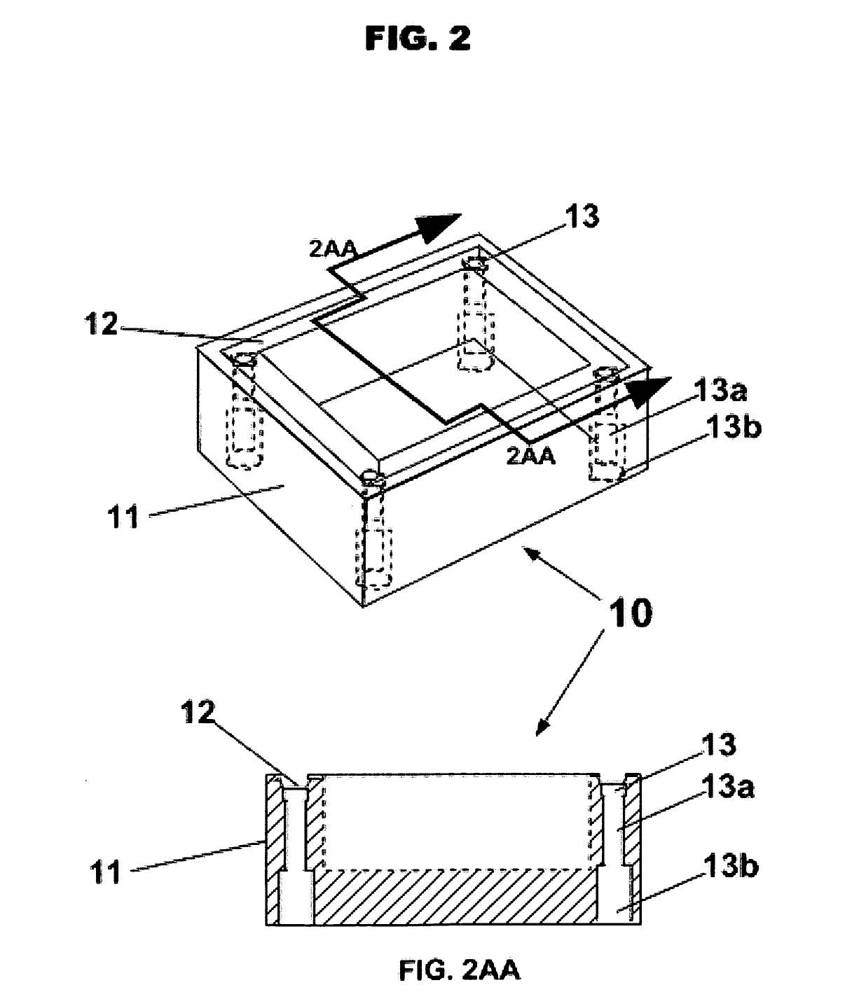

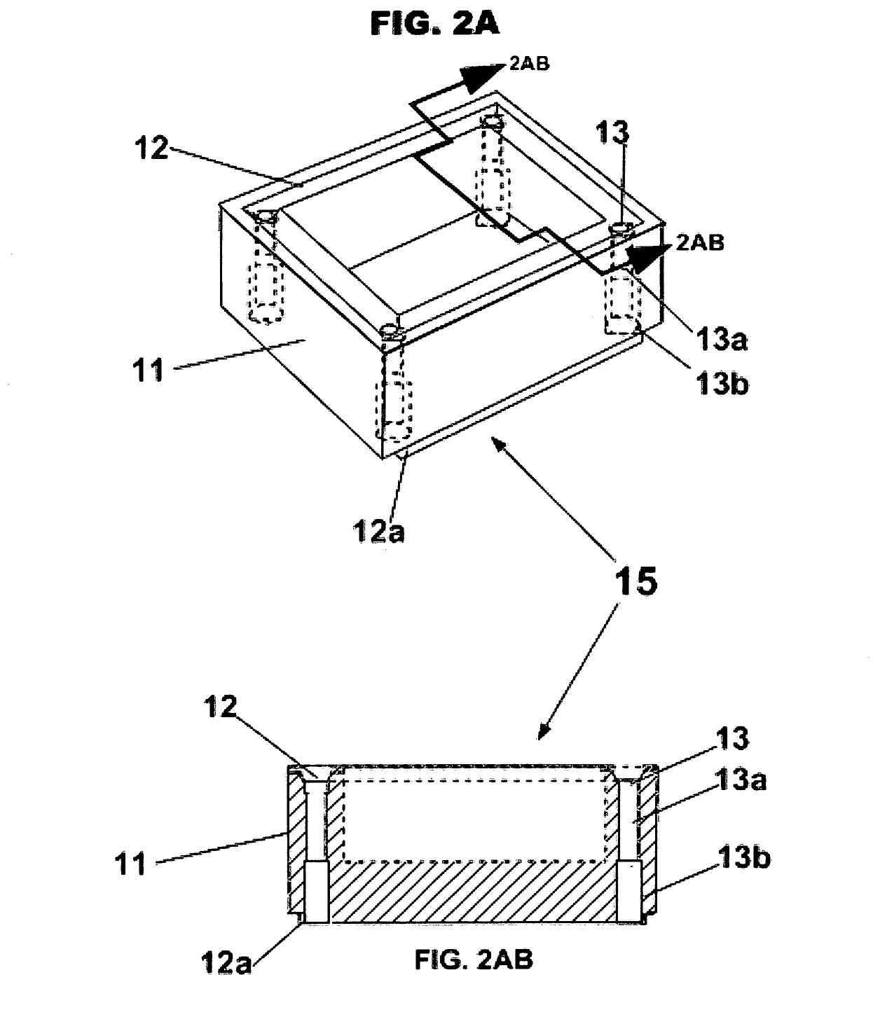

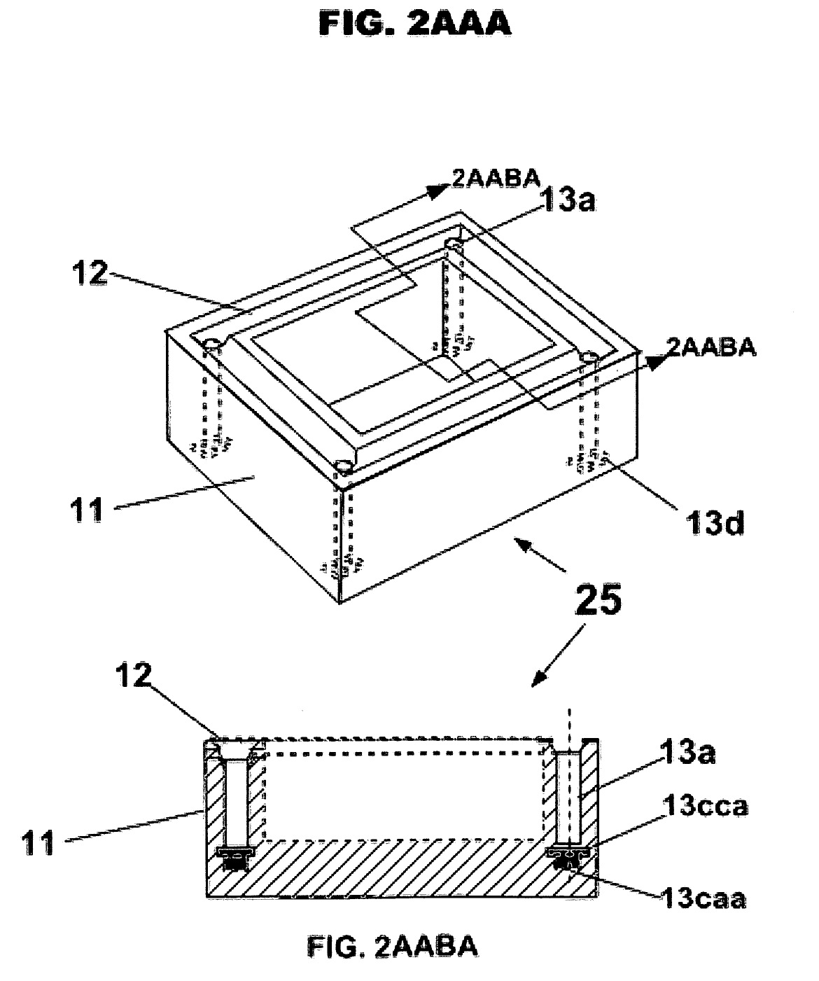

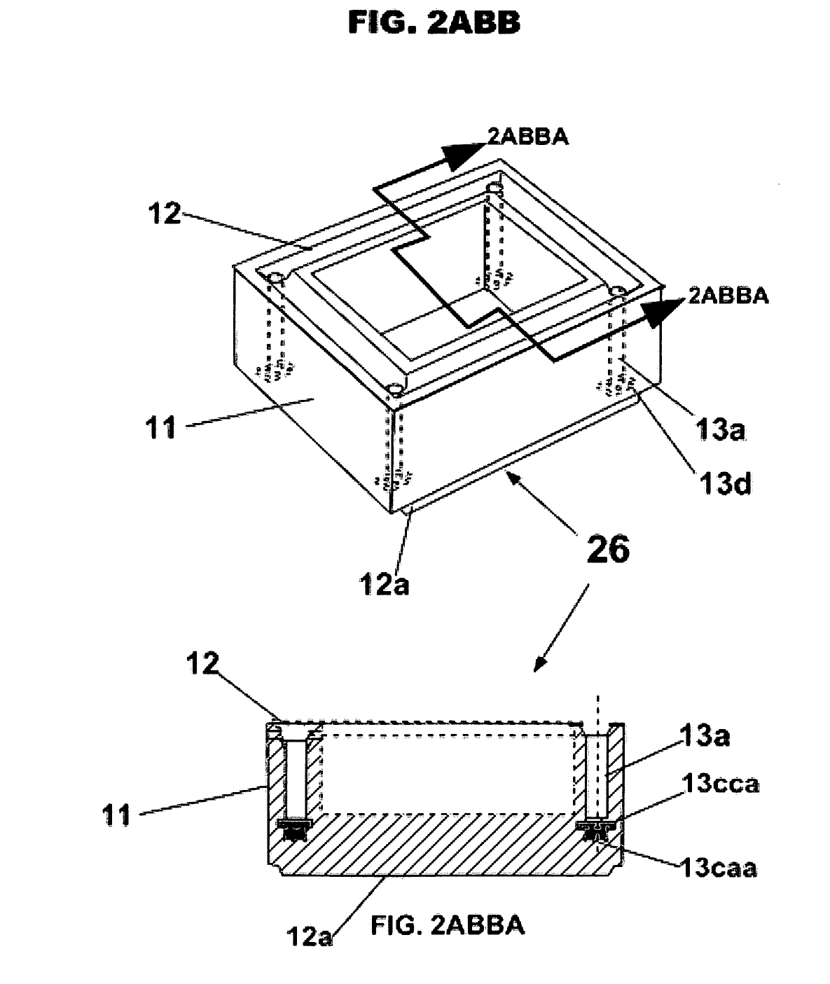

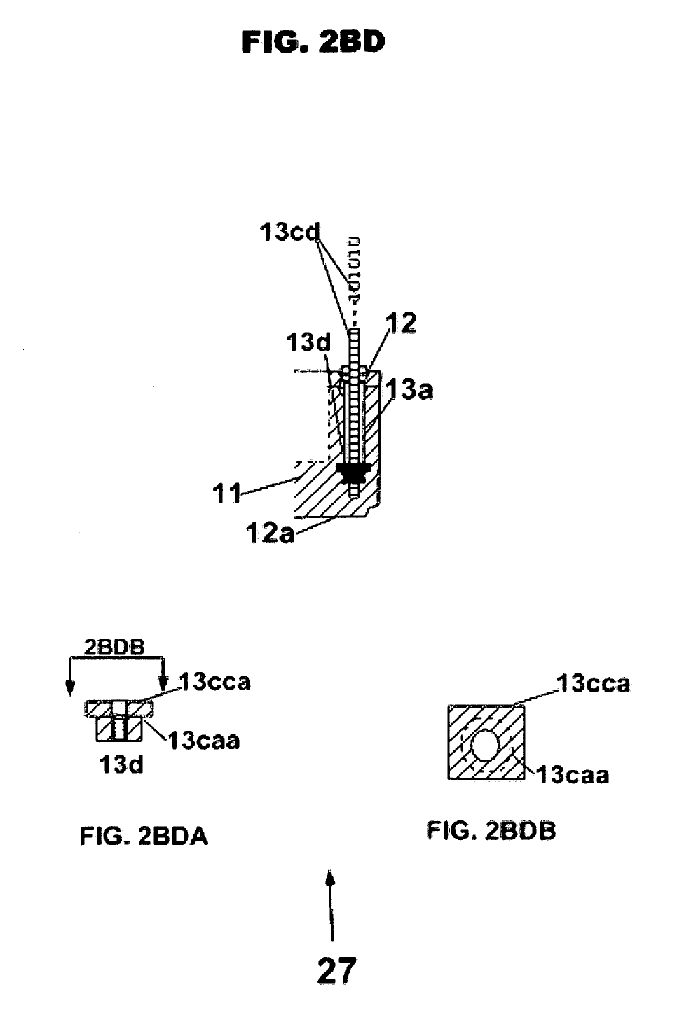

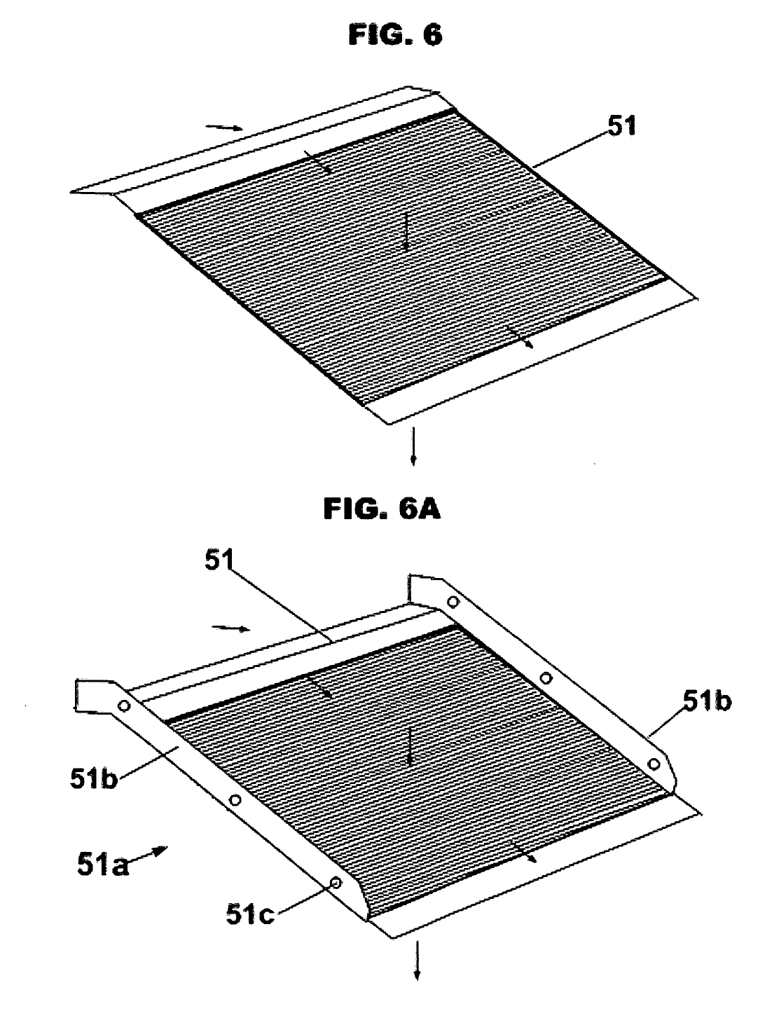

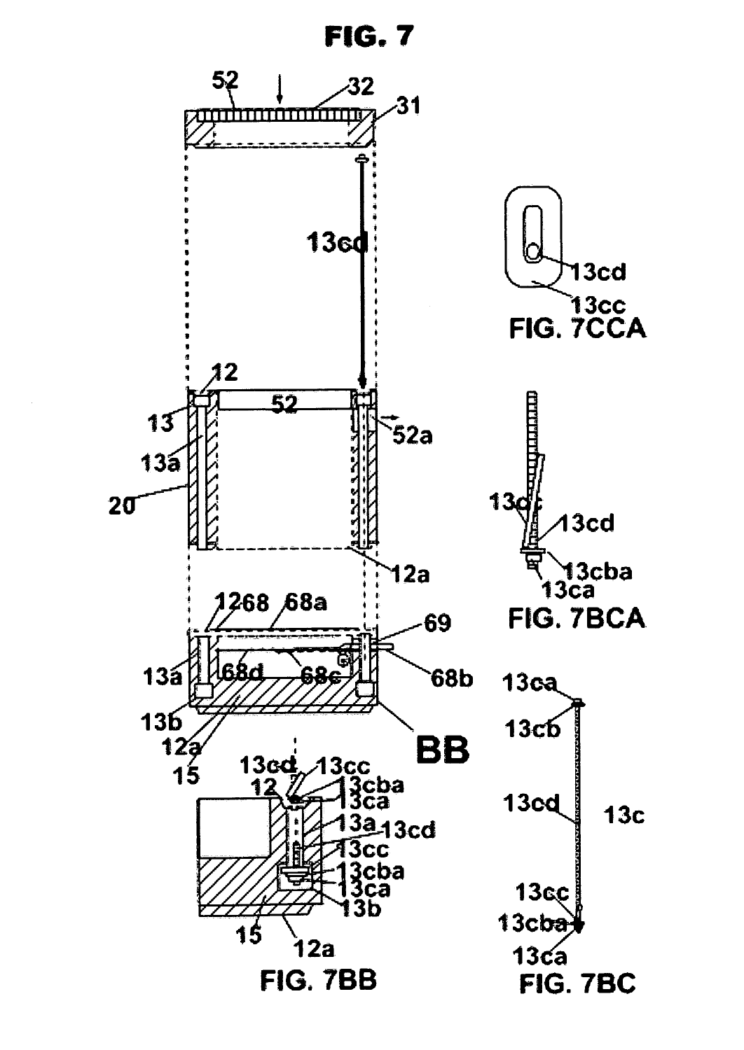

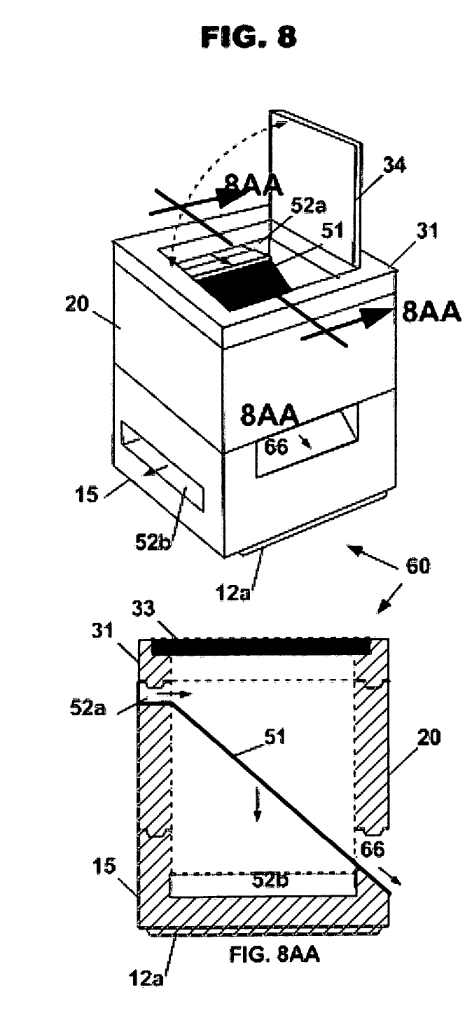

The receiver vault RV, treatment vault TV, and drainage vault DV may comprises a plurality of stacked vault sections 15, 20, 30. Elongated coupling elements CE may be used to fasten these vaults sections 15, 20, 30 together as depicted in FIGS. 2B and 7. FIG. 7 illustrates one embodiment of a receiver vault RV designated by the numeral 50 that functions as raw effluent stilling-well receiver vault. It comprises substantially rectangular vaults sections 15, 20, 30, and a grated cover 32 covering an inlet port 52. A rectangular outlet 52b in the base vault section 15 in the receiver vault RV allows filtered water to escape from my system 70. FIG. 8 illustrates one embodiment of a storm water treatment vault TV designated by the numeral 60. It also comprises stacked vaults sections 15, 20, and 30. The base vault section 15 has stacked thereon the riser vault section 20, and the riser vault section has the cap vault section 30 is stacked thereon. A sidewall 31 of the wall riser vault section 20 has a slot configured to provide a rectangular inlet 52a′ that is in communication with an outlet 52a in the adjacent receiver vault RV upon stacking the vault sections. The receiver vault RV and treatment vault TV are placed together so that facing surfaces of these vaults abut and the inlet 52a′ and outlet 52a are next to each other so they are contiguous and in registration having essentially the same dimensions and configuration (in this embodiment rectangular). Lodged between the cap and riser vault sections is a water-filter such as, for example, a screen 51 mounted on an angle. As shown in FIG. 6 the screen 51 may be a stainless steel, Coanda-style, self-cleaning, non-clogging wedgewire screen sold by Coanda, LLC, of Irvine, Calif., or Hydroscreen, LLC of Denver, Colo. Such screens are discussed in U.S. Pat. Nos. 6,705,049 and 7,584,577. They may be installed either alone or in parallel multiple arrays as appropriate for each system. FIG. 6A shows a screen 51 modified by adding vertical deflectors 51b to enable simplified installation in vaults where the inside diameter (ID) plan dimensions of the vault cavity are oversized or walls are not plumb. This will prevent water leakage past screen 51 as water flows through the screen 51.

With the screen 51 thus positioned, the water is filtered and debris is collected on the surface of the screen 51 and carried by flowing water and gravity out an outlet 66 in the riser vault section 20. The drainage vault DV is in communication with the treatment vault TV via including a rectangular inlet port 66a. The treatment vault TV and drainage vault DV are placed together so that facing surfaces of these vaults abut and the outlet 66 and inlet 66a′ are next to each other so they are contiguous and in registration having essentially the same dimensions and configuration (in this embodiment rectangular). A solid steel cover 33 rests on top of a central opening in the cap vault section 30 and there is an outlet port 69 in the base vault section 10.

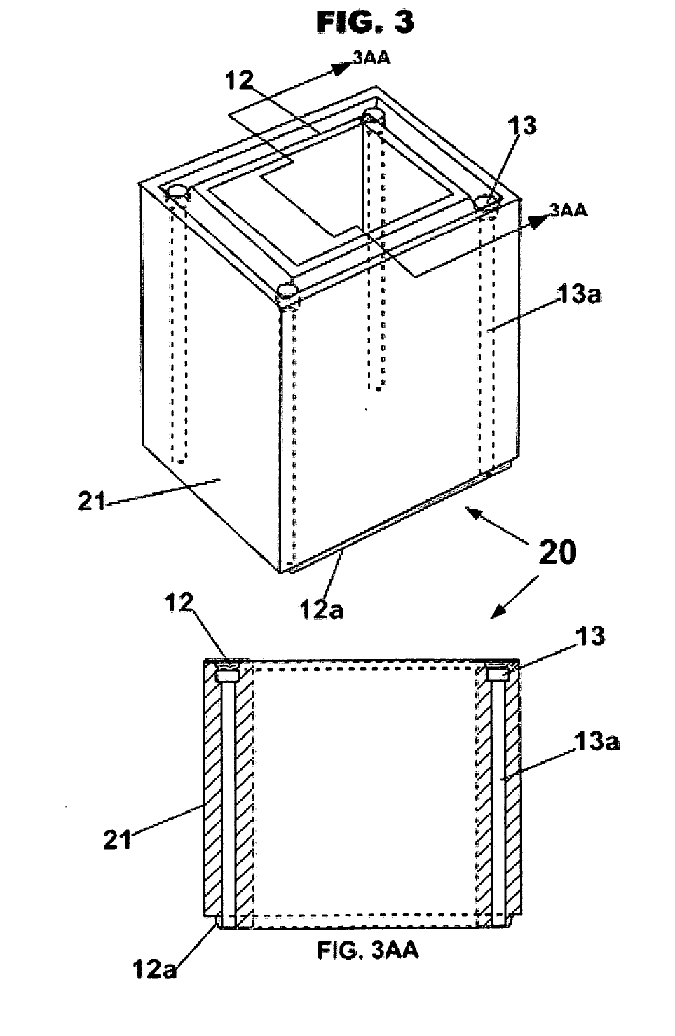

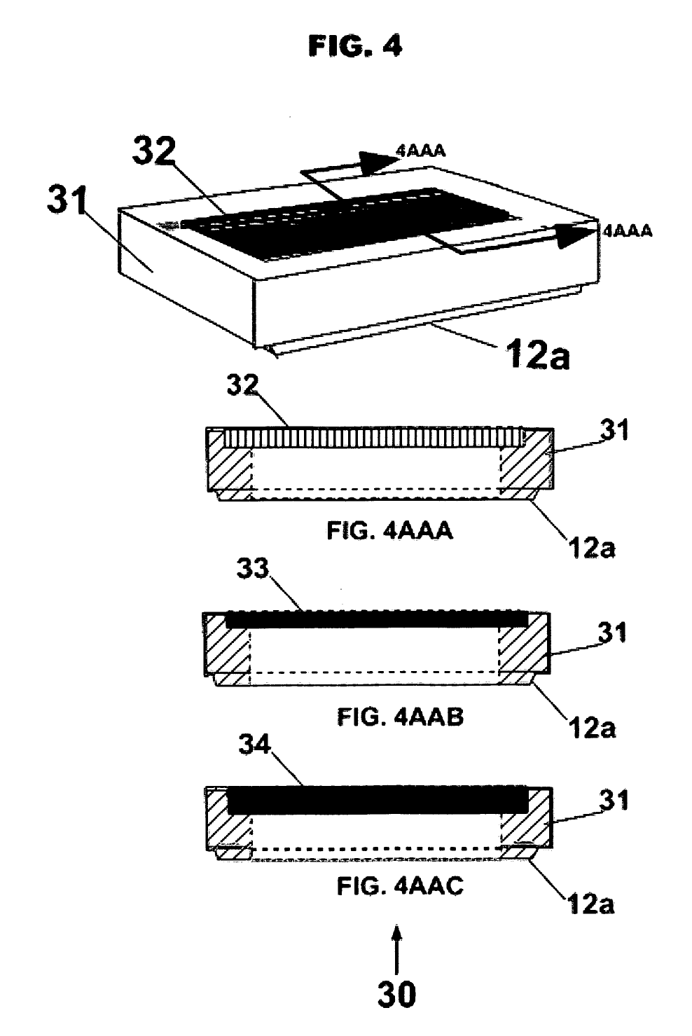

As shown in FIG. 7 a receiver vault 50 comprises the base-riser section depicted in FIGS. 2A and 2AB, the riser section depicted in FIGS. 3 and 3AA and the cap section depicted in FIGS. 4 and 4AAA. This receiver vault 50 functions as a stilling-well to enable water entering through a rectangular inlet port 52 to flow smoothly on discharge through a rectangular outlet port 52a and enter treatment vault 60 shown in FIG. 8 though an inlet port 52a′ (FIGS. 8 and 8AA). Each of the four corners, or optionally in any other sidewall 31, may include a stabilizing steel rod compression/reinforcement device which is especially well-suited for use with modular sections produced of light weight HPFRCC materials. Once inserted, the steel rod compression/reinforcement devices 13c may be tightened to a specific torque level drawing uppermost cavity 13 toward bottom cavity 13b and providing internal support for vault sections assembled using this option.

The base-riser section 15 of receiver vault 50 has a bottom filter 68a (FIG, 7), which is supported on integral support 68 positioned into the interstitial space in a joint between base vault section 15 and vault section riser 20. Hydrocarbon in the water may be collected using floating disposable absorbent-filled pads 68c. Post rain event standing water automatically drains down to the flowline level 68d via an exit pipe 68b and outlet port 69.

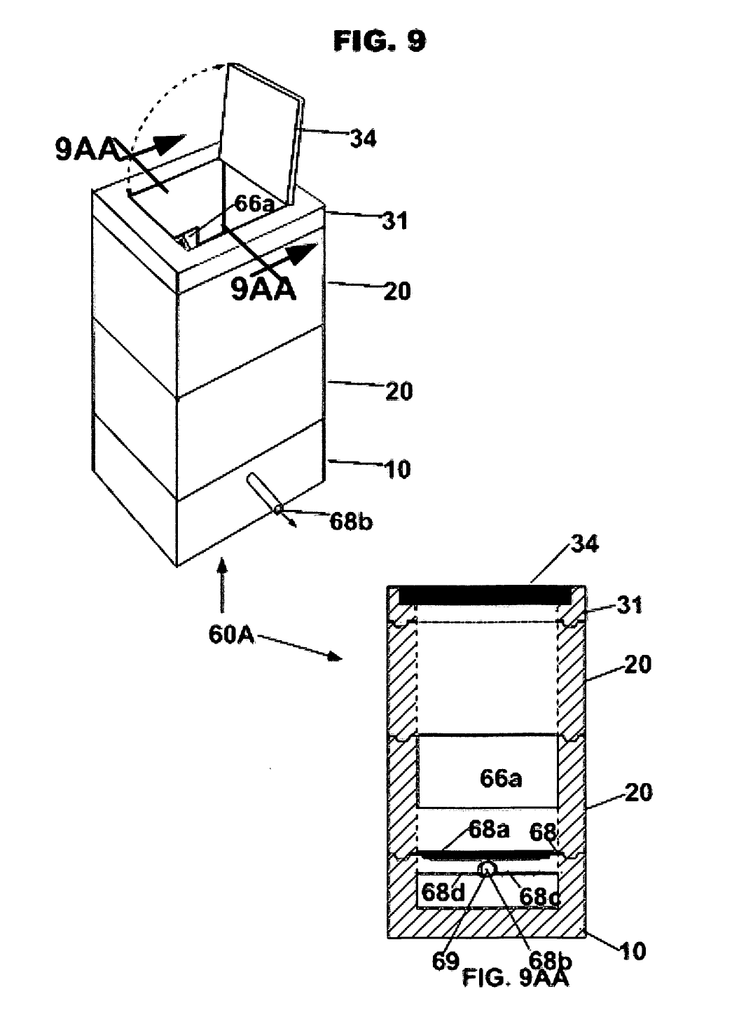

As shown in FIG. 8 a treatment vault 60 comprises a base section 15, riser section 20, and a cap section 30 including a sidewall 31 and an aluminum cover 33. Raw bulk water from a receiver vault 50 (FIG. 7) is received via a rectangular inlet port 52a, travels over and through the screen 51, automatically pushing solids off the outlet end of the screen through the port 66 and draining nearly 100% of its water into the space below the screen, where it can gravity drain through a rectangular outlet port 52b to its destination. As shown in FIG. 9, the vault 60A includes base section 10, riser sections 20 and cap section 30 having a sidewall 31 and aluminum cover 34. Raw bulk solids from the screen 51 (FIG. 6) are received through inlet port 66a following further dewatering as needed is automatically gravity-drained via a PVC pipe element 68b (FIG. 9AA).

FIG. 9AA shows a drainage vault 60A, which functions as a solids receiver and drainage vault of FIG. 9. This drainage vault 60A includes bottom filters 68a supported on support structure 68 enabling water passing through the bottom filter to be automatically gravity-drained via the pipe element 68b inserted through port 69 until the standing water level 68d is below the bottom filter surface as shown. Any hydrocarbon in this water is collected by disposable pads 68c filled with rubberizer or other absorbent material and deployed to float at the optimum collection level.

FIGS. 2 through 6A illustrated various types of vault sections and other components that may be used in constructing my storm water treatment system. FIG. 2 depicts a base vault section 10, including a wall/floor structure 11 having a sidewall 31 and an upper groove G of tongue-in-groove joint 12 formed upon stacking of an upper vault section having a corresponding tongue 12a, for example. The base vault section 10 may be cast in a variety of sizes to enable appropriate system sizing and alignment. Base vault sections 10 may include optional stabilizing cavities 13, 13a and 13b that form a passageway P (FIG. 7) through corners of the embodiment of the base vault section shown in FIGS. 2 and 2AA. Upon stacking of the vault sections, P the passageways through the aligned vault sections are aligned also to enable insertion of a threaded rod 13cd of the stabilizing steel rod compression/reinforcement device 13c (FIG. 7) through the adjacent riser and base vault sections. The stabilizing steel rod compression/reinforcement device 13c connects and applies tension to the assembly vault sections. These stabilizing cavities and steel rod compression/reinforcement devices are particularly useful with modular sections made of lightweight concrete materials such as high-performance fiber-reinforced cellular (HPFRCC) concrete products from Substiwood, Inc. of Milwaukee, Wis. These lightweight concrete materials are discussed in U.S. Pat. Nos. 6,976,345 and 6,911,076.

FIG. 2A and FIG. 2AB depict a base-riser vault section including a wall/floor element 11, an upper tongue-in-groove joint 12, and a lower tongue-in-groove joint 12a. The base-riser vault section of FIG. 2A may be cast in a variety of sizes to enable appropriate system sizing and alignment and to enable placement of this base-riser at whatever elevation is required for optimum system performance. It also employs stabilizing cavities 13 and 13a and 13b that interact with the stabilizing steel rod compression/reinforcement device 13c. There are two embodiments of the stabilizing steel rod compression/reinforcement device 13c. One embodiment shown in FIGS. 2ABB through 2BBD depict a device having a embedded washer/nut assembly 13d embedded in a vault section during formation of such a section, and FIGS. 7 through 7BCA depict another embodiment that is inserted after stacking the vault sections together. Both embodiments of the stabilizing steel rod compression/reinforcement device 13c include a washer 13cca and a nut 13caa aligned so the threaded rod 13cd may be screwed into the washer/nut assembly 13d.

FIGS. 2AAA through 2BD show an embodiment of a base vault section including an embedded washer/nut assembly 13d. In this embodiment the washer 13cca and a nut 13caa that may be welded together before being embedded. During casting of the sections the washer/nut assembly 13d is retained within a mold that is filled with fluid concrete that is subsequently allowed to set and harden. The washer/nut assembly 13d is at the bottom end E1 of stabilizing cavities 13a that form a portion of the passageway P extending through adjacent vault sections positioned to interact with the rod 13cd of the stabilizing steel rod compression/reinforcement device 13c. As best illustrated in FIGS. 2B and 2BA, the threaded rod 13cd is inserted into an upper end of a passageway P extending, for example, through the corners of stacked together vault sections, or through a sidewall 31, and is screwed into the washer/nut assembly 13d and tightened, securing the sections together to form a drain vault.

In FIGS. 2AAA and 2AABA a base vault section is shown without a tongue portion, and in FIGS. 2B and 2BA a base vault section is shown with a tongue 12a portion in its bottom that may interact with a corresponding groove in an adjacent vault section or other component. FIGS. 2ABB and 2ABBA illustrate another embodiment of a base-riser vault section similar to that illustrated in FIG. 2AAA that includes a rectangular tongue 12a portion that may interact with and be seated in a corresponding groove in an adjacent vault section or other component. FIGS. 3 and depicts a perspective view of a hollow riser section 20, including its sidewall 31, a tongue 12a, and stabilizing cavities 13 and 13a.

FIGS. 4 and 4AAA depict a cap section 30, including its wall element 31 and a lower tongue 12a, grated cover 32, which is one of three alternative covers. FIG. 4AAB depicts a cap section with lower tongue-in-groove 12a, wall element 31 and solid aluminum cover 33, and FIG. 4AAC depicts a cap section with lower tongue-in-groove 12a, a wall element 31, and solid steel cover 34. FIGS. 5 through 5AC and 5AA shows three alternative configurations of a modular culvert vault section, In FIGS. 5 and 5AA a culvert vault section 40A is depicted in an open-channel configuration comprised of U-shaped wall and floor element 41 forming a water-carrying channel 42. FIG. 5AB depicts the open topped configuration of the culvert section of FIG. 5 having a removable solid cover 43. FIG. 5AC depicts a permanently closed-topped configuration of the culvert section of FIG. 5.

FIGS. 7BC through 7BB show an alternate embodiment of the stabilizing steel rod compression/reinforcement device 13c′. In this embodiment, a passageway P has opposed ends, an end E2 near a top of the cap vault section and an end near E3 a bottom of the adjacent base vault section 15 immediately below a riser vault section 20. The portions of the passageway P at these opposed ends E2 and E3 are larger in diameter than a central portion of the passageway. The steel rod compression/reinforcement device 13c′ connects the stacked vault sections and comprises the threaded rod 13cd a rod and an open element with an open central section having a diameter that allows the rod to pass freely along the passageway P and move latterly within an open section, for example, the rectangular washer 13cc may be used. When the assembly of the washer 13cca and nut 13caa is first inserted into the end E2 of the passageway P, the washer is titled. The assembly remains in this orientation as it advances along the passageway P, permitting the of the washer 13cc and nut 13ca mounted on the rod 13cd to advance along the passageway until the assembly reaches the end E3 of the passageway. The nut 13caa is aligned with an opening O1 and aligned so the threaded rod 13cd may be screwed into an assembly of the washer 13cca and nut 13caa as shown in FIG. 7BB. The rod 13cd has an upper terminal end E4 configured to fit within the end portion E2 of the passageway and thereby stop further advancement of the rod along the passageway. At a lower terminal end E5 of the rod 13cd, which is received within the end E3 of the passageway P, is an assembly of the washer 13cc and nut 13ca. The nut 13caa has a diameter that is greater than the diameter of the rod but less than the diameter of the central portion of the passageway and less than a diameter of the end portion E3 of the passageway P. The washer 13cca has an oblong central opening O1 through which the rod 13cd passes. Initially the washer 13cc has an initial tilted orientation sitting on the head of the nut 13ca as the assembly enters the passageway P. Upon reaching the end E3 of the passageway P, the washer 13cc under the influence of gravity assumes a substantially horizontal orientation as depicted in FIG. 7BB. The nut 13ca may be in a fixed position, but the washer 13cca is moveable with respect to the rod 13cd to form the two different assembly configurations so the washer 13cc moves between the tilted orientation as shown in FIG. 1BCA and the horizontal locking orientation as shown in FIG. 7BB, preventing withdrawal of the stabilizing steel rod compression/reinforcement device 13c′ from the passageway P.

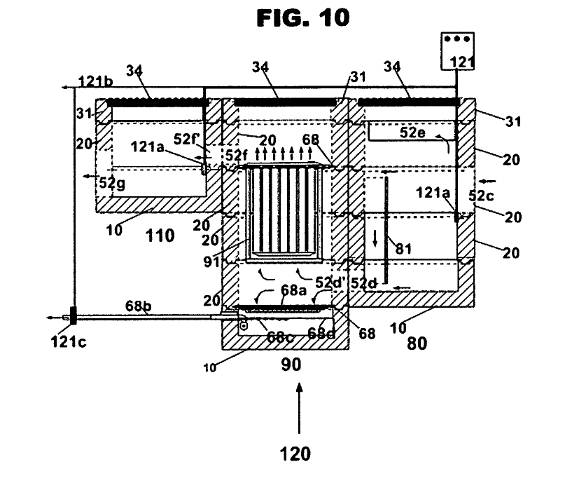

### FIGS. 10-14

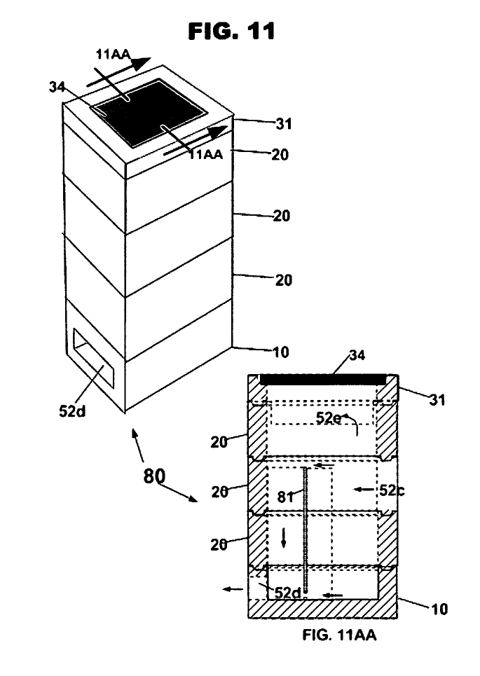

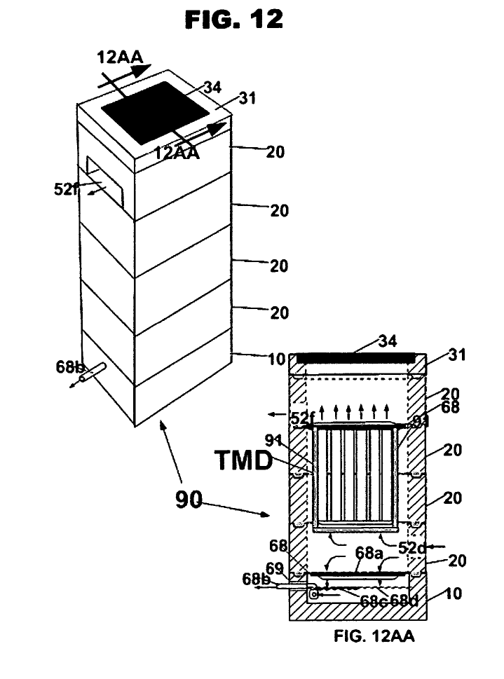

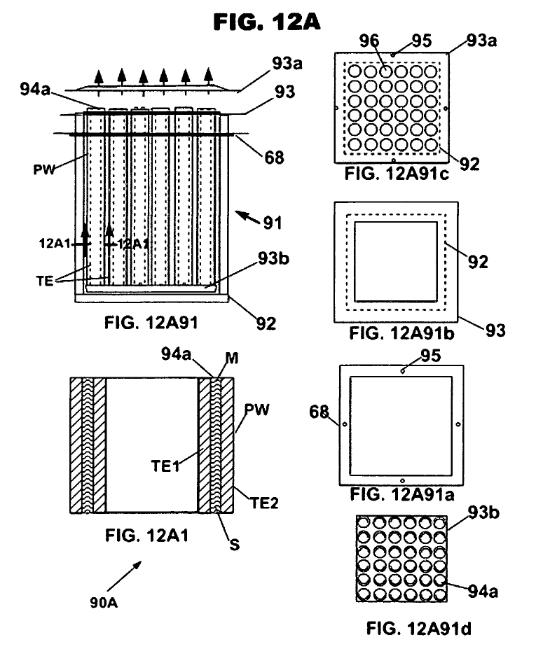

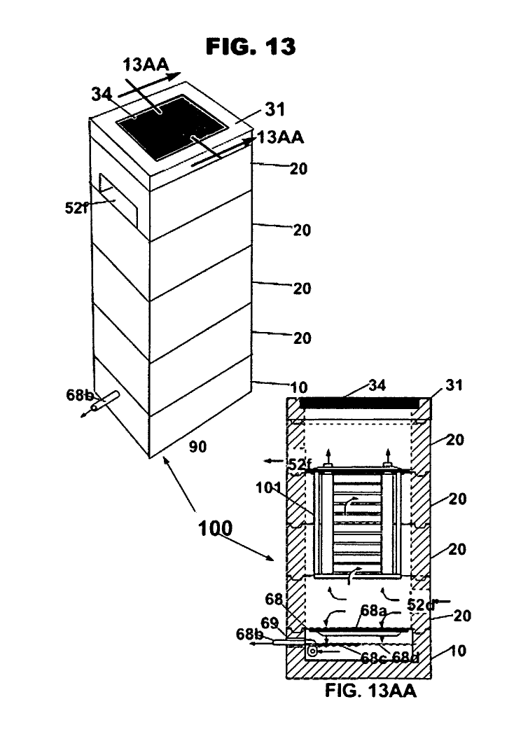

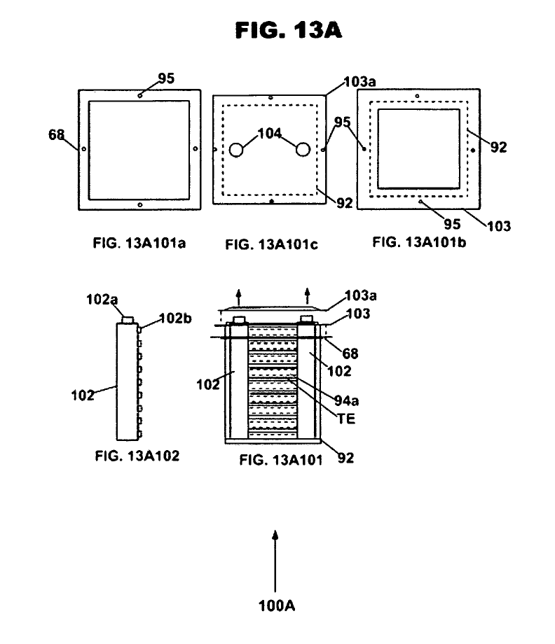

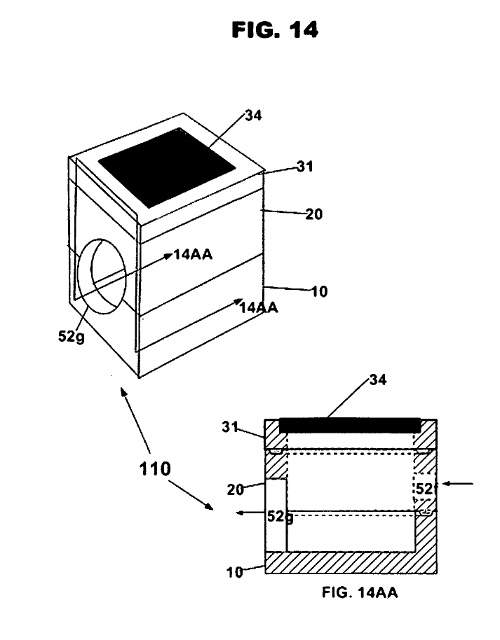

FIG. 10 depicts an embodiment of my treatment system designated by the numeral 120 comprising an influent receiver vault 80 (FIG. 11), a treatment vault 90 (FIG. 12), and a discharge vault 110 (FIG. 14). This system 120 employs a tubular media device TMD, one embodiment of which is shown in FIG. 12A employing vertically oriented tube elements TE and designated by the numeral 90A, and another embodiment of which is shown in FIG. 13A employing horizontally oriented tube elements TE and designated by the numeral 100A. The tubular media device TMD filters and may include a material for chemically interacting with contaminants to remove them from the water, for example, to absorb hydrocarbons or react with cations in the water. The permeable tube elements TE allow water to pass through the tube elements' porous walls PW, collecting on exterior surfaces thereof suspended solids. A single permeable tube element TE may be used or concentrically arranged tube elements may be used. As illustrated in FIG. 12A1, when concentrically arranged tube elements TE are used a smaller diameter tube element TE1 is disposed within a larger diameter tube element TE2 to provide an annular space S between the tube elements. The space S is filled with an appropriate agent to treat the water passing through the tube element TE1 and TE2. Such agent may be, for example, an absorbent, such as MSH modified soybean hull media for cation removal, produced by CleanWater Solutions, LLC of Eau Claire, Wis., using a method for collecting dissolved metals and other cations. MSH media will collect dissolved cationic contaminants.

As shown in FIG. 11, the influent receiver vault 80 comprises of the base vault section 10, three riser vault sections 20, and the cap vault section 30, including a solid cover 34. Water flows into the receiver vault 80 through the rectangular inlet port 52c and out through the rectangular outlet port 52d, which is in communication with the treatment vault 90 through an inlet port 52d′ in a lower portion in the treatment vault. The outlet port 52d and the inlet port 52d′ are configured as discussed above. The rectangular bypass port 52e is in an uppermost portion of the receiver vault 80 and functions to bypass water from the system 120. There is within the receiver vault 80 between the inlet port 52c and the outlet port 52d a weir 81. Water flowing at low volumes to the weir 81 flows under the weir to the outlet port 52d. As volume increases, water also flows over the weir to outlet port 52d. This is done to maximize suspended solids entrainment in the water discharged through the port 52d and minimize solids entrainment in the liquid volume reaching a high flow, bypass port 52e and prevent long term solids buildup upstream of the weir.

As illustrated in FIG. 12, the treatment vault 90 comprises the base vault section 10, three vault section riser sections 20, and the cap vault section 30, including the solid cover 34. An outlet port 52f is in communication with the discharge vault 110 so treated water flows from an upper portion of the treatment vault 90 into the discharge vault. The outlet port 52f is above both the inlet ports 52c and 52d′. An automatic drain-down pipe 68b in the receiver vault 80 functions to dewater solids collected on the filter assembly 67a and automatically drain-down standing water post rainfall for mosquito control. The valve 121c controls the flow of water from the bottom and is opened and closed as discussed subsequently. A filter assembly 68a on the bottom of the treatment vault 90 captures solids prior to water exiting through the drain-down pipe 68b.

As water enters the treatment vault 90 it rises to surround the tubular media device TMD. The water flows through the porous walls PS and out the open ends 94a of tube elements TE, exiting the treatment vault 90 from the outlet port 52f into the discharge vault 110 (FIG. 14). Suspended solids settle by gravity onto a filter assembly 68a near the bottom of the treatment vault 90.

As shown in FIG. 14, the discharge vault 110 includes the base section 10, the riser section 20, and cap section 30, including the solid cover 34. An inlet port 52f is aligned with the outlet port 52f in the receiver vault 90 as discussed above. Water flows from the discharge vault 110 through an outlet port 52g.

FIG. 12A

The embodiment of the tubular media device TMD shown in FIG. 12A includes a tube support assembly 91 (FIG. 12A91) for the vertical oriented permeable tube elements TE that are seated therein. The assembly 91 comprises a support structure 68 that includes a top support structure 93a, a frame support structure 93, a frame 92, and permeable tube elements TE. The top support structure 93a, including tube positioning opening 96 and attachment screw holes 95, overlies the frame 92.

The support structure 68 (FIG. 12A91a) is positioned in the interstitial space between selected riser sections 20. Sub-assemblies illustrated in FIGS. 12A91b and 12A91d, once assembled, can be inserted through and rest upon support structure 68. Then top support structure 93a of FIG. 12A91c can be positioned covering and securing open upper ends 94a of the tube elements TE to support structure 68 using the attachment screw holes 95, thus producing a hydraulic seal which forces all water to flow through the porous walls PW and into the interior of the tube elements TE and then out the ends 94a. After the filtered water flows upward it enters the space above a top support structure 93a and then flows out the outlet port 52f.

### FIGS. 13 and 13AA

As FIG. 13 depicts, the treatment vault 100 using the horizontal permeable tubular media device TMD. The treatment vault 100 comprises the base section 10, the riser sections 20, and cap section 30, the solid cover 34, and the automatic drain-down pipe 68b.

As shown in FIG. 13AA influent water enters via the lower rectangular inlet port 52d from the receiver vault 80, and rises to surround the horizontal tube elements TE of the tube support assembly 101. This allows water to pass through the permeable walls PW, collecting suspended solids on the exterior surfaces of individual tube elements TE. Pairs of tube elements may be concentrically deployed as discussed above and the annular cavity space between the concentric tube elements filled with an appropriate absorbent.

After filling at least one outlet end of each horizontal tube, water flows by gravity into a manifold tank 102 and then flows upward where it can enter the space above a horizontal top support structure 103a and be discharged via an upper rectangular port 52f into the discharge vault 110. Suspended solids settle by gravity onto the bottom filter assembly B68a, as discussed above

### FIG. 13A

The embodiment of the tubular media device TMD shown in FIG. 13A includes a tube support assembly 101 (FIG. 12A91) for the horizontal oriented permeable tube elements TE that are seated therein. The tube support assembly 101 includes a support structure 68, top support structure 103a, frame support structure 103, frame 92, manifold tanks 102 and permeable tubes 94 and 94a. The support structure 68 of (FIG. 12A101a) is positioned in the interstitial space between selected the riser sections 20 (FIG. 13). Then, once the tube elements TE and manifold tanks 102 (FIG. 13A101) have been assembled into a frame sub-assembly of (FIG. 13A101b), this sub-assembly can be inserted through the support structure 68 and a top support structure 103a (FIG. 13A101c), which covers and secures the open upper ends of the manifold tank outlet ports 102a. The support assembly 101 is held in positioned using the attachment screws in the holes 95. This produces a hydraulic seal, which forces all water to flow through the porous walls PW into the interior of the tube elements TE.

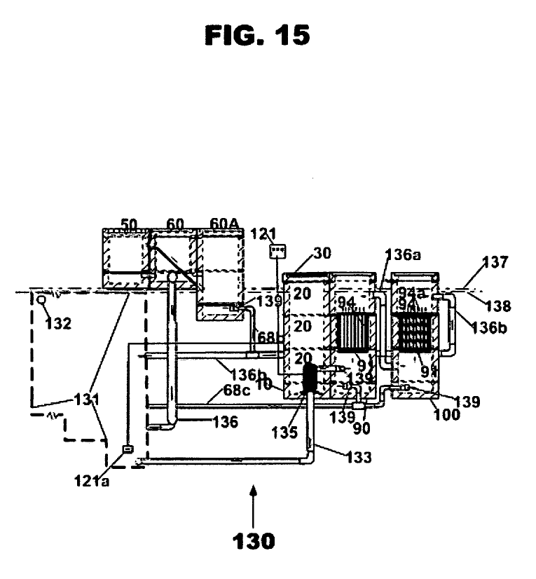

### FIG. 15

FIG. 15 illustrates another embodiment of my system identified by the numeral 130 and is a combination of a system pre-filtration system like that of my system 70 shown in FIG. 1 and a the treatment vault like that shown in FIGS. 12 and 12AA. In the treatment system 130 water, at variable site runoff flow rate(s), passes through a pre-filtration system, that is positioned to enable high flow bypass by gravity via the port 132. This bypass water enters underground retention structure 131 where dewatering/infiltration may occur. By gravity the water drains to the lowest point within the structure 131 and is suctioned, including its entrained solids, by a high-suction pump 135 located in a receiver vault RV. The effluent from the pump 135 is delivered through an elastomeric check valve 139. The valve 139 regulates water flow so its at a fixed flow rate for optimum treatment performance. The water thus flows at this fixed rate into a treatment vault 90 for removal of suspended solids using the vertical permeable tubular filter system 91. Suspended solids are captured on the typical bottom filter 68a (FIG. 7-2AB), which has been omitted in this FIG. 15 for clarity. Filtrate water flows via pipe 136a by gravity into a second treatment vault 100, where a permeable tubular filter system 101 can be installed for removal of dissolved contaminants. The permeable tubular elements TE of treatment vault 100 can also be used for bacterial colonization/removal, following which, water gravity flows via pipe 136b back into the retention structure 131. Automatic drain down is accomplished via pipe 68b back into the retention structure 131. Flow sensing and electrical switching system 121 with liquid level sensor 121a controls power to high-suction pump 135. Low elastomeric check valves 139 are again used to prevent water back flow on the automatic drain down lines 68b. Thus, flow sensing and electrical switching device 121 has a pump control switch 121b when needed, and valve 121c positioned to enable selective control of flow through the automatic drain-down pathway of pipe 68b. When the water level is it at a predetermined height, the pump 135 is actuated and shuts off automatically below this predetermined level.

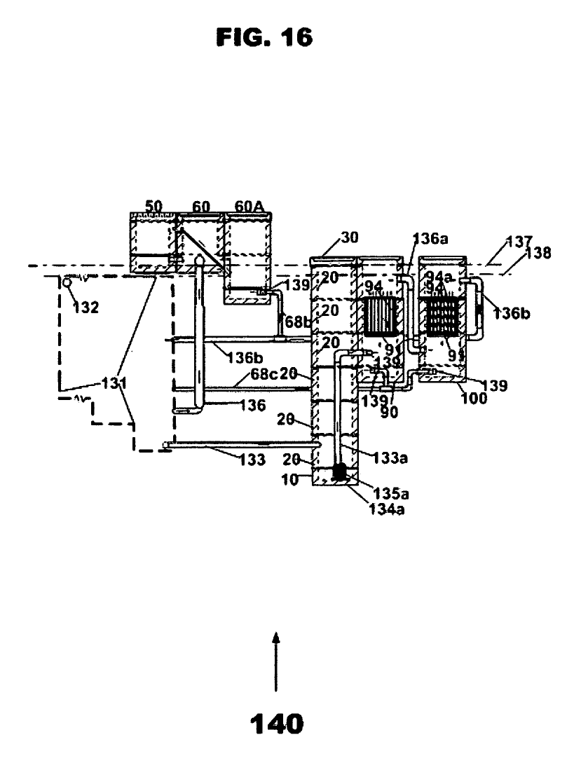

### FIG. 16

In FIG. 16 another embodiment of my treatment system identified by the numeral 140 is depicted, which is similar to that shown in FIG. 15. Water at a variable site runoff flow rate(s) passes through multiple stages of treatment with a retention structure 131 between systems as discussed above. Water from a submersible pump 135a output is delivered through an elastomeric check valve 139 at a fixed flow rate for optimum treatment performance into a treatment vault 90 for removal of suspended solids. Suspended solids are captured on the typical bottom filter 68a (FIG. 7-2AB), which has been omitted in this FIG. 16 for clarity. Filtrate flows via pipe 136a by gravity into the downstream treatment vault 100 for removal of dissolved contaminants. The permeable tubular elements of treatment vault(s) 90 or 100 can also be used for bacterial colonization/removal, following which, water gravity flows via pipe 136b back into the retention structure 131, and automatic drain down is accomplished via pipe 68b back into the retention structure.

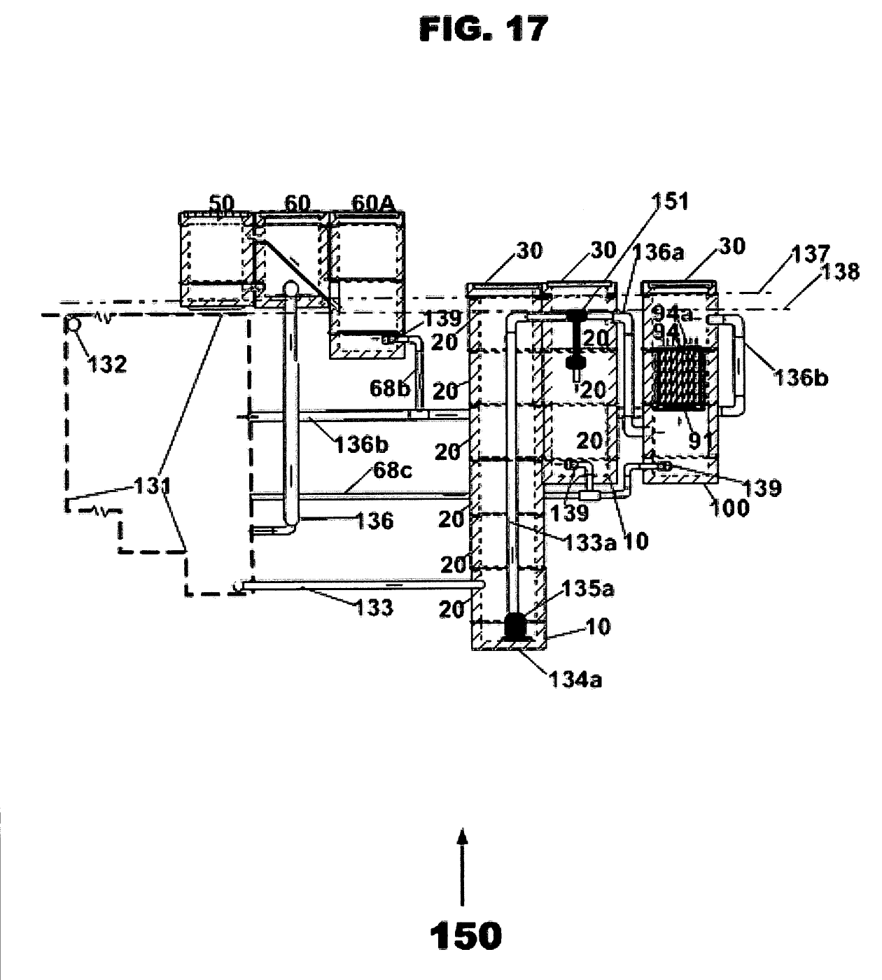

### FIG. 17

FIG. 17 depicts still another embodiment of my treatment system identified by the numeral 150 similar to my systems 130 and 140. In my treatment system 150, in the vault 90 a centrifugal separator 151 such as, for example, produced by J. L. Wingert Co. of Garden Grove, Calif., is used for removal of suspended solids. Suspended solids are captured on the bottom filter 68a (FIG. 7-2AB), again which has been omitted in this FIG. 17. for clarity. Filtrate flows via pipe 136a into a treatment vault 100 for removal of dissolved contaminants using a permeable tube elements TE as discussed above. Suspended solids are bottom-discharged from the centrifugal separator 151 onto the bottom filter 68a. Filtrate flows via pipe 136a into a second treatment vault 100 for removal of dissolved contaminants. The permeable tubular elements TE in the treatment vault 100 can also be used for bacterial colonization/removal, following which, water by gravity flows via pipe 136b back into the retention structure 131, and automatic drain down is accomplished via pipe 68b back into the dewatering/infiltration structure.

### FIG. 18-18AB

A tool and method for cleaning the tube elements TE is illustrated in FIGS. 18 and 18B. The tool is especially useful in cleaning the vertically oriented tube elements TE without removal from a drain vault. The tool is inserted into an open end of an individual tube element 94 and water under hydraulic pressure is forced through the inside of the tube out its porous wall PW. This in turn forces collected suspended solids on the exterior surface of the tube element 94 off the tube element's surface.

The tool has a pistol grip water control valve 187 with a flexible water feed tube 188 supplying clean water to a rigid hollow shaft 182 which passes through the center of two flexible and “Rhino Skin”-coated spheres 181 of slightly larger outside diameter than the inside diameter of the individual tube element 94. A closed distal end of the shaft is closed and a small diameter hole 184 upstream of the distal is drilled normal to the wall of rigid shaft 182, allowing pressurized water to be emitted into the space between the spheres 181. The rigid hollow shaft 182 can be inserted into open ends of the permeable tube elements TE using little physical effort be made to travel the full length and back of the elements. With pressure water applied under the control of the pistol grip valve 187, cleaning of accumulated suspended solids off the exterior tube surface is readily achieved and quickly in the minimum of time. Suspended solids will gravity settle for collection and later periodic removal within the treatment vault.

### SCOPE OF THE INVENTION

The above presents a description of the best mode I contemplate of carrying out my drain vault, system, tool and methods, and of the manner and process of making and using them in such full, clear, concise, and exact terms as to enable a person skilled in the art to make and use. My drain vault, system, tool and methods are, however, susceptible to modifications and alternate constructions from the illustrative embodiments discussed above which are fully equivalent. Consequently, it is not the intention to limit my drain vault, system, tool and methods to the particular embodiments disclosed. On the contrary, my intention is to cover all modifications and alternate constructions coming within the spirit and scope of my drain vault, system, tool and methods as generally expressed by the following claims, which particularly point out and distinctly claim the subject matter of my invention:

1. A drain inlet vault comprising
a plurality of complementary vault sections configured to be vertically stacked one upon the other to form the vault,
said vault sections comprising pre-cast light weight concrete and having a weight that does not exceed approximately 1500 pounds,
said vault sections having at least one sidewall that is devoid of internal structure that would interfere with cutting through the wall at essentially any selected point along the wall, said concrete forming the wall having minimum compressive strength of 2000 psi and minimum flexural strength of 1300 psi.

2. The drain vault of claim 1 including a sealant between engaging edges of adjacent stacked vault sections that is compressed upon stacking of the vault sections to form a seal that prevents leakage between the stacked together vault sections.

3. A drain inlet vault comprising
a plurality of vault sections configured to be vertically stacked one upon the other to form the vault,
said vault sections having sidewalls including vertical passageways that are aligned upon stacking of the vault sections, and
elongated coupling elements extending along the passageways to connect the vault sections together and apply a compressive force against said stacked vault sections to keep said vault sections in a vertical configuration.

4. The drain vault of claim 3 where the vault sections have a substantially rectangular shape with corners in which the passageways are located and said elongated coupling elements include a threaded rod and connecting devices mounted on opposed ends of the rod to manually torque the connecting devices after inserting the rod into a corresponding passageway so the vault sections snugly engage each other.

5. The drain vault of claim 3 where the vault sections are concrete, fiber reinforced plastic or rotationally molded polyethylene.

6. The drain vault of claim 3 where the vault sections are pre-cast of light weight concrete and having a weight that does not exceed approximately 1500 pounds, said vault sections are devoid of internal structure that would interfere with cutting through the wall at essentially any selected point along the wall, said concrete forming the wall having minimum compressive strength of 2000 psi and minimum flexural strength of 1300 psi, and at least one port cut into said wall.

7. The drain vault of claim 3 where
a passageway has opposed ends, a first end near a top of one vault section and a second end near a bottom of an adjacent vault section immediately below the one vault section,
portions of the passageway at said opposed ends being larger in diameter than a central portion of the passageway, and
the elongated coupling element connecting the adjacent vault sections comprising a rod and an open element with an open central section having a diameter that allows the rod to pass freely along the passageway and move latterly within the open section, said rod having an upper terminal end configured to fit within the first end portion of the passageway and thereby stop further advancement of the rod along the passageway and a lower terminal end that is received within the second end of the passageway,
said lower terminal end including an assembly of elements including the open element that is moveable with respect to the rod to form first and second assembly configurations,
said first configuration, when the assembly is first inserted into the first end of the passageway, permitting the coupling element to advance along the passageway until the assembly reaches the second end and
said second configuration, when the assembly reaches the second end, preventing withdrawal of the coupling element from the passageway.

8. The drain vault of claim 7 where the assembly comprises a first stop element and the open element which is a washer, said elements engaging each other and washer element is moveable between a first position corresponding to the first configuration and a second position corresponding to the second configuration.

9. The drain vault of claim 7 where the
said first stop element is in a fixed position at a lower terminal end of the rod and has a diameter that is greater than the diameter of the rod but less than the diameter of the central passageway and less than a diameter of the second end portion of the passageway, and
said washer element has an oblong central opening through which the rod passes, said washer element having an initial tilted orientation sitting on the first stop element as the assembly advances along the passageway and a substantially horizontal orientation on the first stop element when the assembly is in the second configuration.

10. The drain vault of claim 9 where the washer element changes its orientation from tilted to horizontal under the influence of gravity as the second stop element advances to the second end of the passageway.

11. A drain inlet vault comprising
a plurality vault sections configured to be vertically stacked one upon the other to form the vault and to be fastened together snugly, and
a substantially planar, non-clogging and self-cleaning screen within the treatment vault that selectively removes solids having an average particle size greater than 150 microns and collects such particles on a surface of the screen,
said screen being oriented at an angle and sloping between an inlet port and an outlet port and positioned so that substantially all the water flowing into the treatment vault flows through the screen, said screen having a perimeter that is held between adjacent vault sections on a slant,
said vault sections having vertical passageways that are aligned upon stacking of the vault sections, and elongated coupling elements extending along the passageways to connect the vault sections together.

12. A system for treatment of storm water flowing from a watershed site during a rain storm, said system including
a receiver vault and a first and second treatment vaults at said site in communication with each other so water from the site first flows into the receiver vault where turbulence in the water is reduced and then said water flows into the first treatment vault and then from the first treatment vault into the second treatment vault,
said a substantially planar, non-clogging and self-cleaning screen within the first treatment vault that selectively removes solids having an average particle size greater than 150 microns and collects such particles on a surface of the screen,
said screen being oriented at an angle and sloping between an inlet port and an outlet port in the first treatment vault and positioned so that substantially all the water flowing into the first treatment vault flows through the screen.

13. A system for treatment of storm water flowing from a watershed site during a rain storm, said system including
a receiver vault and a treatment vault at said site in communication with each other, said receiver vault having an inlet port into which water from the site flows and a receiver outlet port at a predetermined elevation,
said treatment vault having first and second treatment outlet ports and an inlet port at an elevation substantially the same as said predetermined elevation of the receiver outlet port,
said receiver outlet port and treatment inlet port being essentially contiguous so water flows directly from the receiver vault through the contiguous receiver outlet port and treatment inlet port,
said receiver vault having a predetermined capacity based on the normally anticipated rain fall on said site during a rain storm to allow water to collect and slowly fill the receiver vault to reduce turbulence of water in the receiver vault and to regulate the flow rate of the water through said contiguous ports so said flow approaches substantial laminar flow, a substantially planar, non-clogging and self-cleaning screen within the first treatment vault that selectively removes solids having an average particle size greater than 150 microns and collects such particles on a surface of the screen,
said screen being oriented at an angle and sloping between the treatment inlet port and the second treatment outlet and positioned so that substantially all the water flowing into the treatment vault flows through the screen, exiting the treatment vault through the first treatment outlet downstream of the screen, and
position within the second treatment vault a plurality of permeable rigid tubular devices oriented to enable water to penetrate permeable walls of the tubular devices and discharge from an end thereof and out the second treatment vault.

14. The system of claim 13 where the flow rate of the water flowing through the tubular devices provides sufficient contact time for bacteria entrained in the flowing water to colonize exterior surfaces of the tubular devices.

15. The system of claim 13 where the tubular devices have fine mesh covers.

16. The system of claim 13 where the tubular devices comprise a pair of concentric permeable tubes having a spaced between them filled with water treatment media.

17. The system of claim 13 where the vaults comprise a plurality of pre-formed vault sections having a weight that does not exceed approximately 1500 pounds to allow loading, unloading and placement of such vault sections in excavations using manual labor or lower-load-capacity equipment common to most construction sites, thus enabling shipment of un-assembled, pre-formed vault sections to be economically shipped over long distances exceeding 150 miles.

18. A system of drain vaults at a predetermined watershed site for treatment of storm water flowing from the site including
a first bank of drain vaults in communication with each other to treat storm water flowing from the site, said first bank vaults including a treatment vault and a drainage vault downstream of the treatment vault,
said treatment vault including a substantially planar, non-clogging and self-cleaning screen that selectively removes solids having an average particle size greater than 150 microns and collects such particles on a surface of the screen, said screen being oriented at an angle and sloping between an inlet port and an outlet port in the treatment vault and positioned so that substantially all the water flowing into the treatment vault flows through the screen and solids collected on the screen and flow under the influence of gravity into the drainage vault,
a retention structure in which treated water from the first bank flows and is retained for further treatment,
downstream from the retention structure a second bank having a drain vault including a plurality of permeable rigid tubular devices oriented to enable water to penetrate porous walls of the tubular devices and discharge from an end thereof and said second bank, and
a pump that pumps water from the retention structure at a constant flow rate into the second bank.

19. The system of claim 18 including a flow control device to enable the pump to be operated to transfer water in the retention structure upon sensing when the water level in the drain vault in the second bank is below the tubular devices.

20. A system of drain vaults at a predetermined watershed site for treatment of storm water flowing from the site including
a first and second drain vaults in communication with each other to treat storm water flowing from the site, said second drain vault being down stream from the first drain vault so water flows into the first vault and settles to reduce turbulence,
said first vault including a diversion weir device near an inlet port thereof so that water flows to, under and over the weir device to divert flow to an outlet port of the first vault,
said second vault including a plurality of permeable rigid tubular devices oriented to enable water to penetrate porous walls of the tubular devices and discharge from an end thereof, said water from the first drain vault flowing into the second vault near a lower portion thereof and then upward through the tubular devices and then out the second drain vault.

21. The system of claim 19 including an lower outlet port near a bottom of the first vault where effluent water containing the maximum entrained solids content exits the first vault.

22. The system of claim 22 including an upper by-pass port where effluent water containing the minimum entrained solids content exits the first vault.

23. A tool for cleaning a tube having a porous wall with an internal surface and a predetermined inside diameter, said tool comprising
a elongated shaft having a first end including a manually operated control valve adapted to be connected to a source of cleaning liquid and a second end that is closed,
said shaft being hollow to provide a channel for cleaning liquid flowing internally along the hollow shaft, said shaft having an orifice therein near the second end that is in communication with the channel, and
a pair of resilient elements mounted along the shaft in a fixed position straddling the orifice, each resilient element having a diameter that is slightly greater than the inside diameter of the tube being cleaned,
said resilient elements being compressed upon inserting the tool into an open end of the tube to form a seal between the resilient elements and the internal surface of the tube yet allows the tool to be moved reciprocally as the valve is actuated to enable cleaning liquid to flow along the channel and out the orifice under pressure and through the porous wall of the tube element.

24. The tool of claim 23 where the internal surface of the porous wall is substantially cylindrical and the resilient elements are substantially spherical.

25. The tool of claim 24 where the resilient elements have a tough external skin and a softer internal core.

26. A method of cleaning a tube element with a predetermined diameter and having a porous wall with an internal surface, said method comprising the steps of
(a) inserting into an open end of the tube element a tool that is connected to a source of pressurized cleaning liquid,
said tool including
a hollow shaft providing a channel for cleaning liquid flowing internally along the hollow shaft, said shaft having an orifice therein in communication with the channel that is near a closed end of the shaft, and
a pair of resilient elements mounted along the shaft in a fixed position straddling the orifice, each resilient element having a diameter that is slightly greater than the inside diameter of the tube element being cleaned,
said resilient elements being compressed upon inserting the tool into the open end of the tube element to form a seal between the resilient elements and the internal surface of the tube element yet allows the tool to be moved reciprocally, and
(b) moving said tool reciprocally within the tube element while concurrently manually actuating a valve of the tool so cleaning liquid under pressure flows along the hallow shaft through the orifice and is forced from within the tube element through the porous wall.

27. The method of claim 26 where the internal surface of the porous wall is substantially cylindrical and the resilient elements are substantially spherical.

28. The method of claim 27 where the resilient elements have a tough external skin and a softer internal core.

29. A method of cleaning an array of vertically oriented tube elements in a below ground drain vault, said tube elements having with a predetermined diameter, an open upper end that is accessible for cleaning the tubes, and a porous wall with an internal surface, said method comprising
without removing the array from below ground
(a) inserting into the open ends of the elements a tool that is connected to a source of pressurized cleaning liquid,
said tool including
a hollow shaft providing a channel for cleaning liquid flowing internally along the hollow shaft, said shaft having an orifice therein in communication with the channel that is near a closed end of the shaft, and
a pair of resilient elements mounted along the shaft in a fixed position straddling the orifice, each resilient element having a diameter that is slightly greater than the inside diameter of the tube element being cleaned,
said resilient elements being compressed upon inserting the tool into the open end of the tube element to form a seal between the resilient elements and the internal surface of the tube yet allows the tool to be moved reciprocally, and
(b) forcing cleaning liquid under pressure along the hallow shaft through the orifice and concurrently moving said tool reciprocally within the tube element so cleaning liquid flows from within the tube element through the porous wall.
